(19) United States
(12) Patent Application Publication
(10) Pub. No.: US 2008/0221986 A1
(43) Pub. Date: Sep. 11, 2008

(54) Consumer-choice, incentive based, alternative payment method and advertising system

(76) Inventors: Barry Soicher, Mill Valley, CA (US); Kevin Goodman, Great Neck, NY (US); Honor Gunday, Palo Alto, CA (US)

Correspondence Address: WARD & OLIVO, SUITE 300, 382 SPRINGFIELD AVENUE, SUMMIT, NJ, 07901, US

(21) Appl. No.: 11/716,348

(22) Filed: Mar. 9, 2007

(51) Int. Cl. G06Q 30/00

(52) U.S. Cl. 705/14

(57) ABSTRACT

Disclosed is a consumer-choice, incentive based, alternative payment method and advertising system. The system and method provides a highly efficient and effective means for advertisers to deliver video or other advertisements to a demographically and psychographically desirable audience. The system and method enables users to convert their time spent viewing and/or listening to user-selected advertisements at their convenience into payment rewards (e.g., credits) that may be exchanged for goods and services. Users may exchange these rewards for predetermined or not yet identified goods or services. Furthermore, the system and method tracks, logs, and reports user usage and related statistics.

### FIELD OF THE INVENTION

The present invention generally relates to the field of incentive based advertising. More particularly, the present invention relates to a highly efficient and effective alternative payment method and advertising system whereby advertisers can offer advertisements by a certain method, including via the Internet, to a predetermined demographically and/or psychographically desirable audience. In turn, the system and method enables users to convert their time spent viewing and/or listening to user-selected advertisements at their convenience into payment rewards, including credits, points, and/or money. The user may exchange these rewards for predetermined or not yet identified goods or services. Furthermore, the system and method tracks, logs, and reports user usage and related statistics.

### BACKGROUND OF THE INVENTION

Traditionally, companies, services, and other people or groups wishing to promote products, services, and other offerings have advertised such products, services, and other offerings through a variety of mediums. For example, companies have placed print advertisements in magazines or newspapers, or on billboards or other types of outdoor advertising. Other companies have utilized television or radio to place commercial advertisements in between portions of television and radio shows, respectively. Although these traditional advertising mediums provide advertisers with a useful outlet to reach potential customers, they suffer from certain shortfalls. For example, these forms of advertisements are typically passive (i.e., they generally do not require any interaction or optional selection from the consumer). This can result in, among other things, difficulty gauging an advertisement's effectiveness.

Furthermore, although traditional advertisements reach a wide consumer audience, such advertisements do not provide consumers with any choice for viewing advertisements, enable consumers to affirmatively participate in the consumption of the advertisement, reward consumers for their participation, or allow consumers to convert their time spent viewing and/or listening to advertisements into a means for making payment. They also may be interruptive to the consumer's enjoyment of the underlying content.

The passive and interruptive nature of print, television, radio, and other traditional advertising mediums results in them often being bypassed, “tuned out,” or altogether ignored. For example, readers may flip through the print medium past the advertisements while searching for articles or other items of interest. Similarly, with the increasing prevalence of digital video recording, many television viewers now have the option to fast-forward through commercials in an attempt to more quickly and efficiently watch selected pre-recorded television shows. Television viewers watching live shows may temporarily leave the room or turn their attention to other activities during commercials. The ability for the consumer to ignore these traditional advertisements is understandably undesirable for advertisers. It becomes difficult to gauge the success of such advertisements and advertisers may end up paying for services and benefits they do not in fact receive.

With the advent of the Internet and the onslaught of websites covering every imaginable topic, many companies, including, for example, magazine publishers and their advertisers, have turned to online advertising as an additional or alternative outlet to reach potential customers. For example, in the hopes of reaching a wider audience and gaining additional customers, athletic gear companies may choose to advertise on a sports related website and computer game manufacturers may advertise on a computer game related website.

Typically, these advertisements occur in a passive form. That is, they often appear on scroll or side bars of a website as “banner” advertisements. The advertisement usually provides a link to an external website. If desired, the user may click on this link and navigate to the advertiser's website. However, just as with passive and interruptive advertisements in print media, it is easy for users to ignore the banner advertisements. This occurs in large part because users may view banner advertisements as unsolicited nuisances and must navigate away from the website they chose to view in the first place to go to the advertiser's website.

Furthermore, as there are typically many advertisements on each given page of a website, it is often difficult for users to choose amongst the many advertisements presented. This clutter effect causes some users to all together ignore the advertisements. Additionally, these banner advertisements provide little or no incentive for the website user to click on them, apart from possibly some advertised discount for a certain select product or service.

Alternatively, certain websites offer flash-style advertising whereby a user is forced to view an advertisement before entering the desired website. This advertising method is often a deterrent to the user trying to enter the website and generally viewed as annoying and cumbersome. Furthermore, these flash-style advertisements require the user to watch a specific, pre-determined advertisement in order to gain entry to the particular desired website. Many users ignore or pay little attention to such an advertisement as they had no desire to view it in the first place. Further, most of these types of flash-style advertisements offer an option to bypass the advertisement and proceed directly to the desired website. This bypass option means that many of the advertisements will not be viewed and thus will not achieve the fullest of their desired result—i.e., effectively promote a product or service to a desired audience. Just as with banner advertisements, these flash-style advertisements provide little or no incentive for the consumer to view them.

Several reward based systems are known in the art. One such system provides rewards to a user who clicks on a banner advertisement and reviews a particular advertiser's website. The system discloses providing banner advertisements for a first group of advertisers on a second group's website, linking the banner advertisements to the respective websites of the first group of advertisers, and bringing the user to a central website responsible for providing rewards when the user clicks on the banner advertisement. The system further discloses registering the user at the central website and then bringing the users to the respective website of the first group of advertisers. Unlike the present invention, this system fails to disclose, among other things, offering the user a choice of which advertisement(s) to view, allowing a user to view an advertisement(s) before registering, and enabling users to convert time spent viewing an advertisement(s) into payment for not yet identified goods or services.

Another system known in the art discloses a system whereby advertising consumers register with an advertising server. The advertising server collects consumer profile data from the consumers. The system further discloses a means for advertisers to describe to the server a profile of an ideal consumer and link certain advertisements to such a profile. The consumer then logs onto the system and views system-chosen advertisements selected to fit the consumer's profile. After watching the advertisements, the consumer receives an incentive in the form of an entry into a sweepstakes. Unlike the present invention, this system fails to provide the consumer with a choice of advertisements to view, the ability to view prior to registering, and an alternative payment system whereby users can convert time spent viewing advertisements into payment for not yet identified goods or services.

Yet another system known in the art discloses the harnessing of a volume of unique users to a certain host website. According to this system, online retailers place advertisements or icons on the host website that enable users to click through directly to the online retailer's website from the host website. Rewards offered by the online retailer or a manufacturer of goods sold by the online retailer may be passed on to the user and the host website. The system discloses tracking click through traffic generated by the advertisements or icons placed on the host website and distributing the resultant rewards through specialized software. However, unlike the present invention, this system fails to disclose an advertisement platform together with an alternative payment option that enables a user to select and choose which advertisement(s) to view in exchange for credits that may be exchanged for discounted or elimination of fees on certain goods or services, or in exchange for money.

Still another system known in the art provides a member based interactive advertisement and reward system for providing product specific information and rewards to a consumer member. Such a system is designed to reward users for reviewing product information, providing feedback with respect to the effectiveness of the advertisement, information pertaining to actual purchases of advertised products, and post-sale feedback concerning the product, as well as introducing new users to the system. The system requires that the user visit a specific website, register at the website, including filling out a questionnaire relating to product-specific facts, and view certain system-chosen advertisements related to the selected products. The consumer member then must answer product-specific questions in order to earn cash or discount credit for a subsequent purchase. Unlike the present invention, this system fails to disclose enabling a user to select and view one of a plurality of advertisements. Further, this system fails to disclose an option for users to view advertisement(s) for credits or money before registering and to use those credits as payment for not yet determined goods or services.

A different system known in the art discloses the distribution of incentives related to the purchase of a product or service. This system discloses that the incentive is offered on the condition that the purchaser of the product or service agrees to receive a system-chosen interposed communication. For example, the system may send the purchaser a multimedia message including an advertisement or survey. However, unlike the present invention, this system, inter alia, fails to disclose users viewing user-selected advertisements, and converting time spent viewing such advertisements into payment for not yet identified goods or services.

Yet another system known in the art discloses distributing or obtaining products covered by intellectual property (e.g., copyrighted music) over a telecommunications network. More specifically, the system discloses a consumer viewing and/or interacting with an interposed sponsor's or advertiser's message and in return for such viewing and/or interacting, receiving a product rather than paying for it. The user is required to set up an account and log into the system. The system is designed to choose which interposed advertisement the user will view. That is, the user has no choice in determining which advertisement to view. The system further discloses that the interposed sponsor or advertiser may pay the owner or assignee of the intellectual property associated with the product through an intermediary. Unlike the present invention, this system fails to disclose, among other things, an advertisement platform that enables a user to select and view one or more of a plurality of advertisements in exchange for credits or points towards goods or services, or in exchange for money.

In view of the foregoing, a need clearly exists for a consumer-choice, incentive based, alternative payment method and advertising system that allows consumers to convert their time spent viewing and/or listening to advertisements into a means of making payment for goods or services through rewards consumers receive for choosing and watching or listening to advertisements from one or more of a plurality of advertisers at one or more publisher's mediums (e.g., e-commerce and other electronic website publishers, magazine publishers, newspaper publishers, book publishers, book clubs, music clubs, cable operators, telecommunication companies, and the like). The system and method enables publishers and/or advertisers to establish an account and self manage: their advertisements, website links, and campaigns (in the case of advertisers); and their offers for goods, services, and content to be presented to consumers utilizing the alternative payment method (in the case of publishers). The system and method also provides the ability to track a user's viewing to enable the user to reap benefits and rewards, and to provide feedback to publishers and/or advertisers, including, for example, reporting certain pertinent information relating to, inter alia, the effectiveness of a particular advertisement, and the increased sales generated for the publisher as a result of implementing the disclosed system and method.

### SUMMARY OF THE INVENTION

The present invention generally discloses a consumer-choice, incentive based, alternative payment method and advertising system that allows consumers to convert their time spent choosing and viewing and/or listening to advertisements online or via another medium (e.g., a telecommunications medium or television) into payment rewards. That is, the system and method of the present invention enables users to view user-selected advertisements based on their own actions. The present invention includes a user enrollment process and stores necessary information related to the user so that the user can reap the benefits from viewing certain user-selected advertisements.

The system and method of the present invention presents a plurality of advertisements to a user for selection. The user then selects one or more of the advertisements for viewing. The user then preferably verifies viewing the advertisement after which the user is provided with benefits.

The system and method of the present invention is designed to optimize the effectiveness of an advertisement, and serve as an alternative payment method, whereby the user chooses to participate to earn credits to pay for all or a portion of a variety of goods or services ranging from, for example, magazines to books to car washes to groceries to DVDs to music CDs to cable TV to utility bills. Optionally, users may be rewarded with money electronically deposited into a user's bank account or similar. The present invention includes a multi-level reach to maximize the exposure to users to participate in the system. For example, as described in more detail below, the present invention may utilize external websites, emails, television programming (e.g., live, on-demand, pay-per-view, digital video recordings), telephonic communications (e.g., mobile telephones, interactive voice response systems), car navigation systems, public displays, and the like. The system and method also utilizes market research, lead generation, and other methods, techniques, and tools to maximize the effectiveness of the advertising campaign.

The present invention enables publishers (e.g., e-commerce and other electronic website publishers) to establish an account to offer customizable co-branded webpages on the system's website (hereinafter referred to as the “advertisement platform”). The consumer is given the opportunity to view video advertisements in return for credits to be used towards the purchase of the publisher's goods, services or content. The system further enables these publishers, as well as their advertisers and/or the advertisement platform's advertisers, to offer a plurality of advertisements for user viewing preferably via co-branded webpage(s) of the advertisement platform. The advertisement platform's administrator preferably controls the content and access to a publisher's co-branded webpage(s), preferably based on the select publisher's preferences. This control and access may be manually set or automated based on certain settings of the advertisement platform.

Additionally, the publishers can directly control the content of and access to such pages. Advertisers may directly upload their own advertisements and control user access and viewing of such advertisements. For example, the advertisement platform's administrator or the advertiser may set the number of total times a unique user may view an advertisement, the total number of times an advertisement may be viewed by all system users, and certain criteria the user must meet to be eligible to view the advertisement (e.g., demographic, age, target sites, etc.).

The present invention may also provide an alternative payment system and method. A user may choose and view and/or listen to one or more of a plurality of advertisements immediately, or at the user's leisure. In turn, the user is rewarded with credits to be used as an alternative payment for goods or services. Alternatively, a user may be rewarded with money electronically deposited into the user's bank account or the like.

For example, consumers may be offered an alternative payment option during the checkout process on a publisher's website. That is, when a consumer decides to purchase a certain product or service (e.g., a magazine subscription from a magazine publisher's website) the user is given the option to view certain advertisements to obtain credits that may be used to pay for a part of the product or service, or depending on the value and number of credits, may be used in exchange for the product or service with no supplemental out-of-pocket exchange of money required.

More specifically, suppose a user goes to a magazine publisher's website and desires to purchase a magazine subscription. During checkout, the magazine publisher's website presents a user with an option to earn credits with which to pay for the subscription, or one or more issues of the magazine, with the user's trading credits previously earned or to be earned from having chosen to select and view one or more of a plurality of advertisements. The user then chooses whether to accept or reject this option. If rejected, the user proceeds with the checkout process and pays full cash price for the magazine subscription. If accepted, the user will proceed to the advertisement platform.

Publishers' websites may also be set to include “pop-ups” as users either navigate to certain webpages on the website or as they choose to navigate away from the publisher's website entirely. The pop-ups would provide the user with an incentive to “Click here to select and view advertisements” or “Click here to join the advertisement platform” (or similar). The incentive is preferably provided in the form of credits to be used as an alternative payment for certain goods or services. It is also possible for the user to be rewarded with actual money (e.g., money may be electronically transferred to the user's bank account after the user selects and views one or more of a plurality of advertisements via the advertisement platform).

Optionally, links may be included on certain websites (e.g., magazine publisher websites) to navigate to the advertisement platform outside of a checkout process. For example, a link on a magazine publisher's website may direct the user to click on it to earn points/credits (e.g., “Click here to earn a free subscription” or similar). By clicking on the link, the user reaches the advertisement platform for the purpose of earning points/credits towards the purchase of the magazine publisher's magazine. The user may then select and view advertisements and receive points/credits. In this scenario, the system preferably determines which advertisements the user may be offered to view based on which website the user navigated from. This ensures that the user is likely of the magazine publisher and/or their advertisers' desired demographic, etc. Other determining factors may also be utilized based on the information given when the user registers with the system, such as a user's age, marital status, job, and interests.

Emails may also be sent to a select group of email addresses informing them of rewards that they can receive for choosing and viewing advertisements. The select group may be determined based on various criteria. For example, the group may comprise current or past subscribers to a certain magazine. Preferably, a link is provided to proceed directly to the advertisement platform. The user then enrolls (if not previously enrolled), and chooses and views certain advertisements, as described above. Emails are also preferably sent to past users of the system to encourage them to return to the advertisement platform to gain other discounts, payment credits, or money in exchange for selecting and viewing one or more of a plurality of advertisements.

The system and method of the present invention is not limited to website and email advertising. It can also be implemented in, for example, newspapers, magazines, other print mediums, television programming (e.g., live, on-demand, pay-per-view, digital video recordings), telephonic communications (e.g., mobile telephones, interactive voice response systems), car navigation systems, public displays, and the like. For example, a newspaper, magazine, or other print medium may include an advertisement advertising a certain website address that a reader may go to at his leisure to select and view advertisement(s) in exchange for credits to be used as an alternative payment for a variety of goods and services or in exchange for actual money. These advertisements may be specific to the print medium (i.e., advertisements that solicit a reader to go to the website at his leisure to select and view advertisement(s) in exchange for credits or discounts toward the particular print medium or related mediums) or general to the advertisement platform (i.e., advertisements for the advertisement platform itself).

Publishers may also advertise a website as a standard commercial during live television. As with the print medium advertisements, the commercial encourages a viewer to go to the specific website to choose and view certain user-selected advertisement(s) and, in turn, receive credits for viewing such advertisement(s).

The offer to select and view advertisements via the advertisement platform may also appear prior to the renting of a pay-per-view movie or show. For example, the offer to select and view advertisements may offer to provide a viewer credits to offset the cost of his cable bill or credits towards other goods or services. The offer solicits a viewer to go to a website (e.g., the independent advertisement platform or a cable company's website comprising the advertisement platform) at the viewer's convenience to select and view the online advertisements. Advantageously, the user can first watch the pay-per-view movie or show and then at any future time (or within a certain amount of time) go to the advertised website to select and view advertisements in exchanges for credits, money, or the like. Alternatively, the user is provided with an option to select and view one of a plurality of commercials directly on the television in exchange for credits, money, or the like. Again, the user may choose when to watch the commercials (i.e., before watching the pay-per-view movie or show or at any time after).

A user may also be offered the opportunity to earn credits by listening to audio advertisements by telephone. The user may learn of this audio advertisement option through a variety of mediums, including, for example, while waiting to be connected to a telephone conversation, via a text message from a cellular service provider, via a print advertisement appearing on the telephone bill itself, or through any of the above-discussed mediums (e.g., Internet, television, etc.).

The user is preferably able to not only choose which of one or more of a plurality of advertisements to watch or listen to, but importantly also choose where and when to watch or listen to the user-selected advertisement(s). Advantageously, this provides the user with the ability to defer watching or listening to an advertisement until he chooses to do so. Furthermore, it is also possible for users to earn credits without first determining which good or service they will exchange the credits for. This enables the user to earn and save his credits, which may then be used at his discretion (preferably within certain system-set limits). The user may also select certain advertisements to view at a later time. The advertisement platform stores the user's selections. When a user logs into the advertisement platform the user is able to view any of the previously selected advertisements.

The advertisement platform is preferably a separate website and independent of the originating website (e.g., a publisher's website). However, this independence is preferably transparent to the user as it appears as if the advertisement platform is just another webpage—or inset page—of the originating website. Alternatively, the advertisement platform may actually be integrated as part of the originating website. It is preferably organized into topics or channels of advertisements, which comprise video advertisements such as commercials or other rich media advertising content. This organization scheme may be controlled by the advertisement platform's administrator or each publisher/advertiser with an account to the advertisement platform's service. Alternatively, it may be automated by the advertisement platform based on certain publisher/advertiser based criteria.

As an initial step, upon navigating to the advertisement platform, users preferably create an account (if one has not already been created), which includes at least a login and password as well as any other information deemed necessary. For example, other additional information may include, but is not limited to, information regarding a user's name, address, age, demographic, job, gender, interests, marital status, and desire (or not) to be contacted by advertisers, the publisher, or the advertisement platform in the future. This additional information may help to match certain users with a group of appropriate advertisements, as well as permit the advertisement platform to contact users with updates, reminders, offers, and the like.

The system remembers the user's information for future visits to the advertisement platform. Optionally, the system also enables the registration from a publisher's site to be passed to the advertisement platform, and vice versa. The advertisement platform and the publisher's site may collect and share user information.

In certain instances, a user may select and view advertisements and, in turn, become eligible to receive credits, payment discounts, or actual money prior to creating an account. That is, a user may choose to log in and/or create an account after viewing the user-selected advertisements, so that the credits are then attributable to that account. This option works especially well in the checkout process scenario, but may also be implemented in the email query or other scenarios.

Upon navigating to the advertisement platform and preferably logging in (or creating an account if necessary), the user selects and views one or more advertisements. In the magazine publisher example, the advertisers preferably include the same or similar advertisers that advertise in the magazine itself that the user is attempting to subscribe to. Advantageously, this provides the advertisers with an additional advertising outlet that more effectively reaches desired advertising targets.

In contrast to a magazine, where the reader can easily bypass and ignore a print advertisement, in the system and method according to the present invention, an online viewer does not have such option since the user only views advertisements upon choosing to do so. Moreover, the user that has chosen to participate in the advertisement platform has an incentive to view the advertisement, namely, to receive discounts, payment credits, or money in exchange for selecting and viewing one or more of a plurality of advertisements.

The system records which advertisement(s) the user views and correlates it to a point system, or credits earned by the user. The system verifies that the user has viewed and/or comprehended the advertisement. For example, the system may ask questions, either to test the user's knowledge of the advertisement or to query the user regarding certain market data or other important information pertinent to the specific advertiser. Alternatively, the system may verify viewing by asking the user to type a code that appears at the conclusion of the advertisement. Preferably, the user is required to enter the code within a predetermined time (e.g., a set number of seconds) thereby ensuring the user's attention to the advertisement at the peril of not obtaining credit for the viewing. Such information underlying the viewing may then be reported to the advertiser and/or company.

After the user accumulates a certain number of points/credits, the system preferably notifies the user that he has received enough points/credits to be eligible to trade them as payment. The system also preferably notifies the user of the type of discount or payment credit and if any additional discounts or payment credits are available for viewing more advertisements. Alternatively, the system may electronically transfer funds into a user's bank account or similar in exchange for the user selecting and viewing advertisement(s).

At any point, a user may log directly into the system and view his status. The status report may include, but is not limited to, the number of points/credits earned towards a certain discount or payment credit, summary of goods or services obtained in connection with the point/credits, the number of points needed to earn a certain discount or payment credit, which advertisement(s) he has viewed, and which advertisement(s) he is still eligible to view.

A user may also indefinitely re-watch any previously viewed advertisement, although typically not for credit and rather for the user's enjoyment. It is also contemplated that depending on the advertiser's intention, a user may earn additional credits for viewing the same advertisement up to a pre-determined maximum number of times. The user may receive full credit or a diminishing portion of full credit for each subsequent viewing up to the maximum number of viewings, as may be determined by the advertiser. A user may also email invitations to third parties to participate in the advertisement platform; such invitations may include actual advertisements from the advertisement platform, or a link to the advertisement platform. The user will preferably receive a certain amount of credits for each successful solicitation of a third party.

The system preferably controls the number of times each user may view a certain advertisement. The system also implements controls capable of ensuring that each user viewing each advertisement is unique thus maximizing the benefit to the advertiser.

The system of the present invention also provides reports to the publisher, their advertisers, and/or the advertisement platform's advertisers that utilize the system, including, but not limited to, statistical and billing reports, demographic profiles, and the like. Preferably, the statistical reports comprise pertinent information relating to viewed advertisements, similar viewed advertisements, click through information, user choices, etc. The billing reports preferably provide a bill to each advertiser based on a flat fee for each advertisement that is fully consumed and verified as watched, along with aggregated or individual user information, depending on user preferences and authorization.

The advertisers will pay to participate in the service provided by the advertisement platform by committing to a set dollar amount of advertising (either via pre-payment or to be billed at a later time). The advertisement platform tracks the number of advertisements confirmed viewed for credit, and then draws down the advertiser's account a pre-determined price per confirmed view based on users viewing the advertisements. The advertisement platform may alternatively bill the advertiser. The system preferably charges a commission to the advertiser based on fully viewed advertisements. The advertisement platform then uses the revenues received from the advertisers to pay publishers for the benefit due to the users who have exchanged their credits for such benefits from the publisher or actual seller (if other than publisher). In this way, the publisher receives actual money payment for the benefits redeemed by users. Alternatively, the advertiser might have the ability to pay the publisher directly, in which case the advertisement platform derives revenue in the form of commission due from the advertiser, the publisher, or both.

Optionally, the system may have a predetermined arrangement with one or more publishers through which the system can purchase goods or services (e.g., magazine issues or subscriptions) at set prices. The publisher is paid as users earn credits towards the goods or services by selecting and watching advertisements, which have been previously paid for by the advertiser (as discussed above). Thus, the system will likely earn a profit as it will have generated more revenue from the advertisers than it will have expended in purchasing the goods or services on behalf of users.

In the magazine publisher example, the publisher will still receive the full value for subscriptions as any portion of the purchase price paid in the form of user credits will be realized by the publisher as money paid to it by the system. The system may also offer a pay-as-you-go or bill me later option, as explained in detail below.

Therefore, it is an object of the present invention to provide a consumer-choice based advertisement platform.

It is also an object of the present invention to provide an incentive based advertisement platform.

Another object of the present invention is to provide an alternative payment system.

Still another object of the present invention is to provide a separate advertisement platform environment organized into various channels or topics of video and rich media advertising content.

A different object of the present invention is to provide multi-level reach through websites, email, radio, television, print mediums, telephonic systems, and the like.

Still a different object of the present invention is to email offers to consumers soliciting them to participate in the advertisement platform.

Still yet a different object of the present invention is to provide an inventory of a plurality of advertisements that consumers choose to view in order to earn payment credits or other discounts or money.

Another object of the present invention is to funnel certain advertisements to certain users based on certain user criteria.

A further object of the present invention is to discern between users, and to control whether a user is offered the opportunity to earn credits, discounts, or money.

Further, an object of the present invention is to enable the system to charge a commission based on verified fully viewed advertisements.

Still another object of the present invention is to provide a verification mechanism for determining whether advertisements have been fully viewed, and only charging for such fully viewed advertisements.

Another object of the present invention is to provide reports or information summaries to users, publishers, and advertisers alike.

Still another object of the present invention is to provide billing and payment options to publishers and/or advertisers.

Yet another object of the present invention is to provide an additional outlet for reaching a selected advertising demographic through active advertisements.

Another object of the present invention is to enable a user to register before or after selecting and viewing an advertisement.

Further, an object of the present invention is to allow users to receive a portion of certain goods or services before watching the total number of required advertisements if the user promises to and actually does watch the total number required advertisements.

Furthermore, an object of the present invention is to send reminder emails to users with status updates and other communications.

An additional object of the present invention is to enable advertisers to further solicit users based on user preferences.

Yet another object of the present invention is to provide users with the ability to opt-in to learn more from the advertisers and/or receive other offers from the advertisement platform.

Finally, an object of the present invention is to provide users with a click through option to the advertiser's website upon viewing such advertiser's advertisement(s).

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 depicts a flow diagram showing the preferred process utilized by the consumer-choice, incentive based, alternative payment method and advertising system to solicit users to navigate to the advertisement platform, and to choose and view one or more of a plurality of advertisements in exchange for reward credits.

FIG. 2 depicts a sample screen shot of a publisher's website soliciting a user to participate in the consumer-choice, incentive based, alternative payment method and advertising system of the preferred embodiment according to the present invention.

FIG. 3A depicts a sample screen shot of the front page of the advertisement platform for use with the consumer-choice, incentive based, alternative payment method and advertising system of the preferred embodiment according to the present invention.

FIG. 3B depicts a sample screen shot of the front page of the advertisement platform when a user scrolls over a selected advertisement for use with the consumer-choice, incentive based, alternative payment method and advertising system of the preferred embodiment according to the present invention.

FIG. 4 depicts a sample screen shot of a guest user viewing a selected advertisement on the advertisement platform for use with the consumer-choice, incentive based, alternative payment method and advertising system of the preferred embodiment according to the present invention.

FIG. 5 depicts a sample screen shot of the registration Ajax Layer on the advertisement platform for use with the consumer-choice, incentive based, alternative payment method and advertising system of the preferred embodiment according to the present invention.

FIG. 6 depicts a sample screen shot of a user's account information page of the advertisement platform for use with the consumer-choice, incentive based, alternative payment method and advertising system of the preferred embodiment according to the present invention.

FIG. 7 depicts a sample screen shot of a verification screen of the advertisement platform for use with the consumer-choice, incentive based, alternative payment method and advertising system of the preferred embodiment according to the present invention.

FIG. 8 depicts a sample screen shot of a confirmation screen of the advertisement platform for use with the consumer-choice, incentive based, alternative payment method and advertising system of the preferred embodiment according to the present invention.

### DETAILED DESCRIPTION OF THE DRAWINGS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment of the present invention.

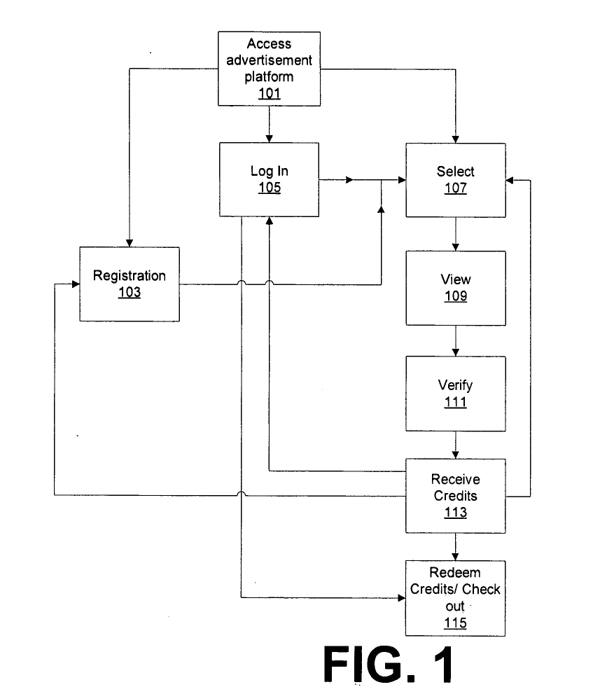

Referring first to FIG. 1, depicted is a flow diagram showing the preferred process utilized by the consumer-choice, incentive based, alternative payment method and advertising system to solicit users (i.e., consumers) to navigate to the advertisement platform, and to choose and view one or more of a plurality of advertisements in exchange for reward credits. The term “users” and “consumers” are understood to be used interchangeably herein.

The process begins with a consumer navigating to the advertisement platform (step 101). This may occur in a variety of ways. For example, a user may be presented with a banner advertisement at a magazine publisher's website to encourage him to navigate to the advertisement platform to receive a discount, payment credit, or money. The banner advertisement on the magazine publisher's website may state “Click here to earn a subscription to Magazine X” (or similar) where Magazine X is a certain magazine offered on a magazine publisher's website. Alternatively, a user may be presented with a similar option during the online checkout process for Magazine X. During checkout, the user is offered the option to earn credits by choosing and viewing certain advertisements; the credits may then be used to pay for issues of or a subscription to Magazine X (or other similar magazines).

If the user accepts the magazine publisher's offer (i.e., clicks on the link from the banner advertisement or checkout process), the user proceeds to the advertisement platform. The advertisement platform may be integrated into or separate from a publisher's website.

Several other methods of solicitation may also be used. For example, the system may also solicit users to navigate to the advertisement platform using email. The system sends an email to one or more email addresses. An email may be sent to a current subscriber of a certain Magazine X offering him a discounted or free subscription to Magazine Y or an email may be sent to a former subscriber of Magazine X offering him a discounted or free subscription to Magazine X in return for selecting and viewing certain advertisements.

Offers to participate in the advertisement platform, or offers for goods or services able to be earned via the advertisement platform, may be placed in newspapers, magazines, and other print mediums. For example, a newspaper, magazine, or other print medium may include an offer that advertises a certain website address that a reader may go to at his leisure to select and view advertisement(s) in exchange for credits to be used as an alternative payment for a variety of goods, services, and content, or alternatively in exchange for actual money.

The system may also advertise on television programming (e.g., live, on-demand, pay-per-view, digital video recordings), telephonic communications (e.g., mobile telephones, interactive voice response systems), car navigation systems, public displays, and the like. For example, the advertisement platform or a particular publisher or advertiser may advertise a website as part of a standard commercial during live television. As with the print medium advertisements, the commercial encourages a viewer to go to the specific website to choose and view certain user-selected advertisement(s) and, in turn, receive credits for viewing such advertisement(s).

The offers to participate in the advertisement platform may also appear prior to the renting of a pay-per-view movie or show. For example, the offer to participate offers to provide a viewer credits to offset the cost of his cable bill or credits towards other goods, services, or content. The advertisement solicits a viewer to go to a website (e.g., a cable company's website) at the viewer's convenience to select and view the online advertisements provided through the advertisement platform.

Advantageously, the user can first watch the pay-per-view movie or show and then at any future time (or within a certain amount of time) go to the advertised website to select and view advertisements in exchange for the credits to be applied as payment for all or part of the purchase.

Alternatively, the user is provided with an option to select and view one of a plurality of commercials that may be delivered directly on the television in exchange for credits. Again, the user may choose when to watch the commercials (i.e., before watching the pay-per-view movie or show or at any time after).

A user may also participate in the advertisement platform via a telecommunications medium. The user preferably dials a telephone number and chooses and listens to one of a plurality of advertisements in exchange for credits, payment discounts, or money. This telecommunications advertisement platform may be used alone or in conjunction with the online advertisement platform.

A user may be solicited to participate in a telecommunication advertisement platform in a variety of ways. For example, a user may hear an offer while waiting to be connected to a called party. The telephonic offer may encourage a listener to enter certain digits or speak certain words on the listener's phone to choose and listen to a plurality of advertisements, again in exchange for credits, discounts, or money. The listener may choose to listen to the advertisements at the present time or at a later time. The latter situation is likely more desirable as it enables the listener to listen to the advertisements at his leisure. Importantly, this will eliminate or minimize any inconvenience to the user/listener waiting to be connected to the called party. The telephonic offer may alternatively provide a website address that a user/listener may go to in order to select and view one or more advertisements to earn credits, discounts, or money.

Once the consumer accesses the advertisement platform, the consumer may choose to register (step 103), log in (step 105), or select one of a plurality of advertisements to view (step 107). If the consumer has not previously registered and chooses to do so as an initial step, the consumer proceeds to register with the advertisement platform (step 103). Certain consumer information is collected and stored. Minimally, a consumer preferably enters an email address and creates a password. Other information may also be collected, including, but not limited to, consumer interests, age, gender, marital status, occupation, and demographic information, and opt-in preferences concerning a variety of potential future contacts. After registering, the consumer proceeds to select which advertisement he would like to view (step 107).

Returning consumers may immediately log in upon accessing the advertisement platform (step 105). The consumer enters the appropriate identification information (e.g., user name and password). Upon logging in, the returning user proceeds to select one of a plurality of advertisements to view (step 107).

A consumer, whether a first time or returning user, may also choose to select one of a plurality of advertisements to view (step 107) prior to registering or logging in. The advertisement platform provides the consumer with a plurality of advertisements to choose from and view, and preferably controls which of the plurality of advertisements that consumer is eligible to view based on certain criteria. The advertisement platform may control which advertisements a consumer is eligible to view based on certain information known about the user, such as which website the consumer navigated from or what email solicitation the consumer received.

The advertisement platform preferably tracks users by creating and maintaining a session ID while the user is utilizing the advertisement platform. In this way, the advertisement platform can keep track of which advertisement(s) the user has viewed and reward the user for such viewing after the user logs in and/or creates an account, as appropriate.

For example, a consumer may navigate from Magazine X's website. There may be Z number of advertisers who advertise in Magazine X that the magazine publisher has contracted with who also advertise via the advertisement platform. The consumer is then able to view advertisements from the Z advertisers. Each of these advertisers may have one or more advertisements that the consumer may view. Furthermore, additional advertisements from advertisers that do not advertise with Magazine X may also be offered for a consumer's selection and viewing.

Other criteria may be used in conjunction with or in alternative to simply using the Z advertisers who advertise in Magazine X. This criteria may include, but is not limited to, age, gender, interests, demographic information, and other criteria that the advertisement platform's technical algorithms deduce based on gathered data. The system then determines which advertisements match the user's profile and allows the user to select from those advertisements. The system also determines viewing eligibility based on whether the maximum number of viewings of a certain advertisement has been reached. Such criteria are preferably determined by the advertiser and the advertiser's campaign budget.

The user is then given clear instructions to select (step 107) and view the advertisements (e.g., watch the video advertisements) (step 109) in exchange for certain rewards. Preferably, each advertisement specifies the length of time and the size of the reward (e.g., the running time of the video advertisement and the credits that the user will receive to be used as alternative payment for a good or service).

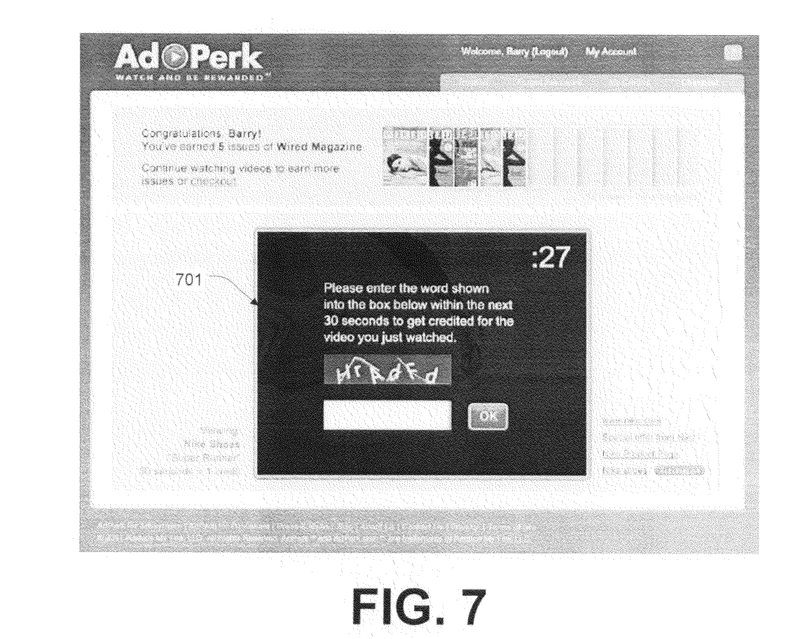

After viewing the advertisement, the system verifies that the user has viewed and/or comprehended certain information relating to the advertisement (step 111). For example, the verification may be as simple as entering a certain word in a provided box within a certain time after completing the viewing of the selected advertisement (as shown in FIG. 7). The system may also present the user with one or more questions relating to the advertisement or other information pertinent to the advertiser. Such information is collected and preferably reported to the publisher and/or advertiser.

Upon verification of viewing, the system awards the user with a certain number of pre-determined credits associated with viewing the advertisement (step 113). Alternatively, the user may be rewarded with money electronically deposited in the user's bank account or similar. If given credits, the user may then choose to redeem the credits (if eligible) and/or check out (step 115), register (step 103), log in (step 105), select additional advertisements to view (step 107), re-watch the advertisement (whether for additional credit or not, depending on advertiser's preference), or email the advertisement or a link thereto, which may include an explanation and/or invitation to the email recipient. At any time, the user may check his account status, including, for example, check the number of credits he has earned.

After the user has registered, he may return to directly to the advertisement platform, log in, and select and view additional advertisements in order to become eligible for a reward. That is, the user may spread his viewing over a period of time. This amount of time may be limited by the advertiser or advertisement platform. After the time has elapsed, the user may lose the credits he has earned.

The system may also offer a pay-as-you-go or bill me later option. For example, a user may sign up to receive a monthly magazine subscription for one year. Instead of having to view X number of advertisements prior to receiving the subscription, the user may agree to view X/12 advertisements per month over the course of a year. The user will then watch X/12 advertisements before a certain date each month and then will be eligible to receive the next month's issue. The advertisement platform preferably sends periodic reminder emails to the user informing the user of his status—how many advertisements he has viewed, how many he still needs to view, by what date, etc. If the user fails to view the minimum number of required advertisements, he forfeits the remaining issues.

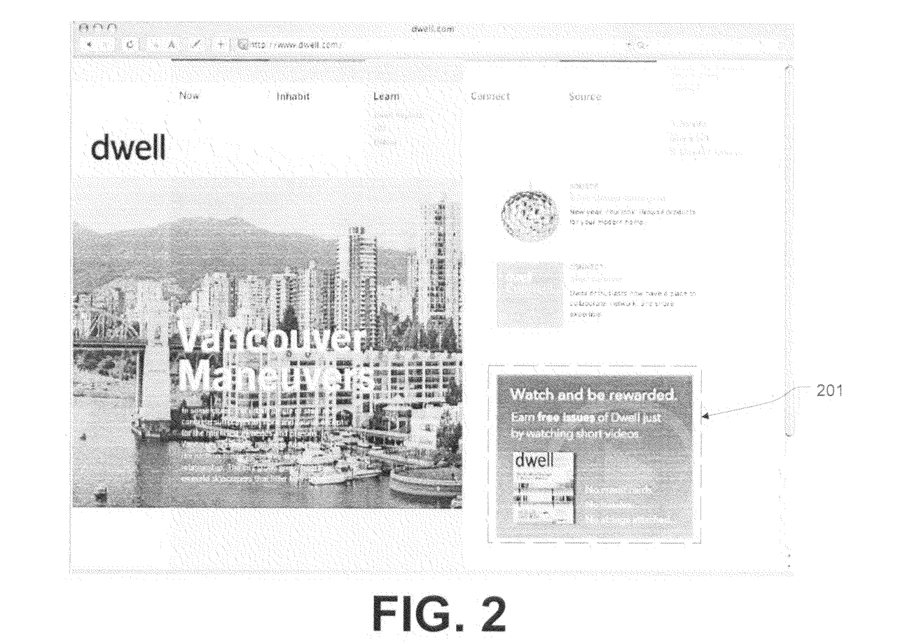

Turning next to FIG. 2, depicted is a sample screen shot of a publisher's website soliciting a user to participate in the consumer-choice, incentive based, alternative payment method and advertising system of the preferred embodiment according to the present invention. The website includes a link 201 soliciting a consumer to “Watch and be rewarded” (or similar). Link 201 navigates the consumer to access the advertisement platform 101.

FIG. 2 shows one of many ways that a consumer may be solicited to participate in the consumer-choice, incentive based, alternative payment method and advertising system of the present invention. Other advertising forums may be used, for example, newspapers, magazines, other print mediums, television programming (e.g., live, on-demand, pay-per-view, digital video recordings), telephonic communications (e.g., mobile telephones, interactive voice response systems), car navigation systems, public displays, and the like.

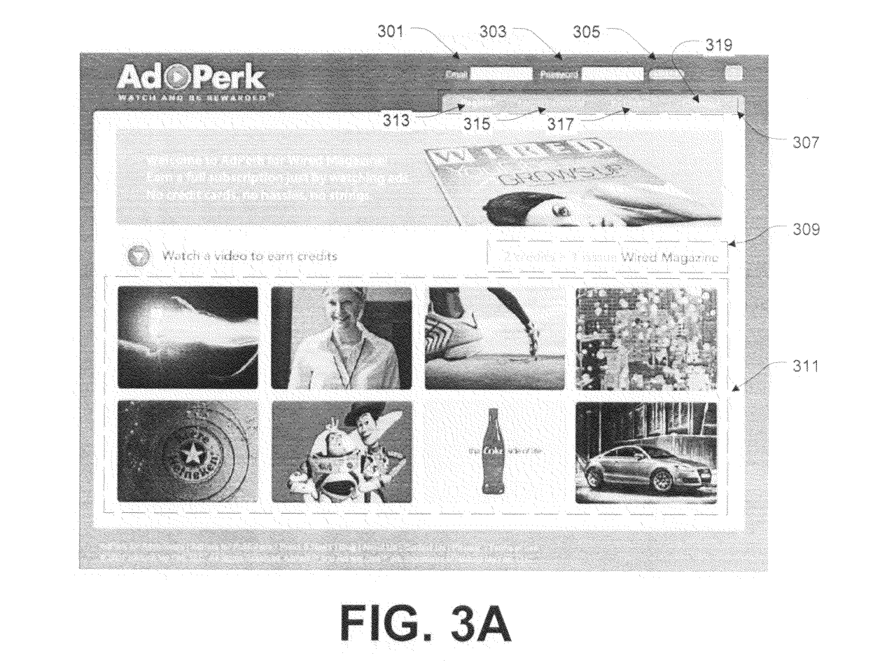

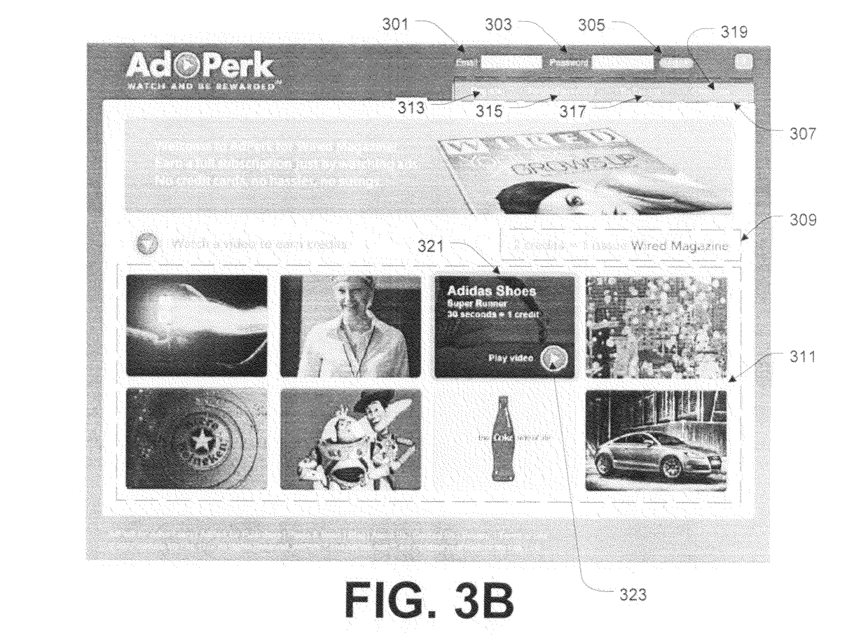

Referring next to FIGS. 3A-8, shown are screen shots of various portions of the advertisement platform in accordance with the present invention. For simplicity, the screen shots are shown with respect to earning credits to be used as alternative payment for a magazine. However, one of skill in the art will readily appreciate that the present invention is not limited to magazine subscriptions and can be equally applied to any good, service, or content. Furthermore, the present invention is not limited to credits and may also reward users with money deposited into a user's bank account or the like. All of the webpages shown may be co-branded pages for the advertisement platform and a publisher or advertiser, or may be webpages integrated into a publisher's website.

First, FIG. 3A depicts a sample screen shot of the front page of an advertisement platform 101 for use with the preferred embodiment of the consumer-choice, incentive based, alternative payment method and advertising system according to the present invention. A consumer is able to log in by entering his email address at input 301 and password at input 303 and clicking on login icon 305 (as shown at step 105 of FIG. 1).

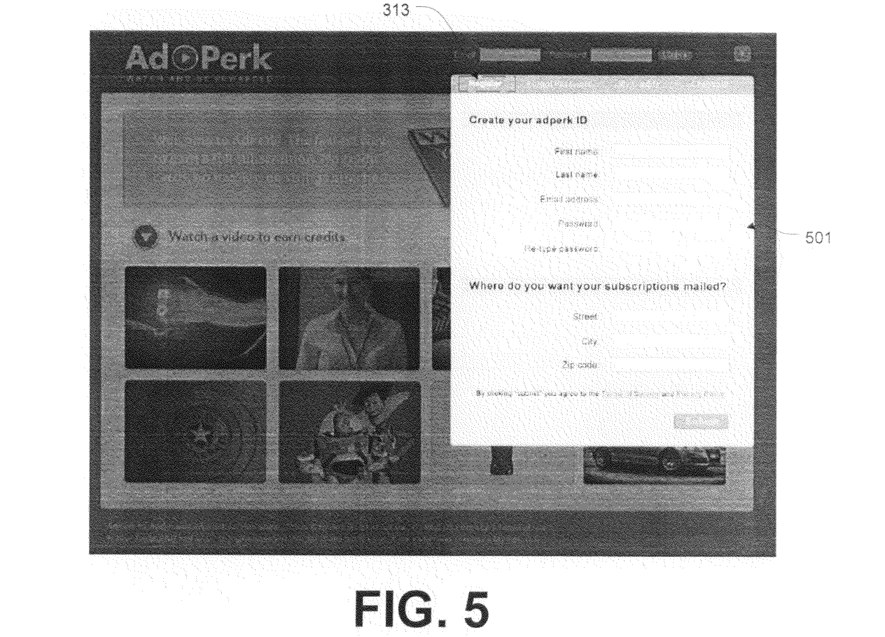

The consumer may also scroll over or click on one of the icons shown in box 307. For example, the consumer may scroll over or click on Register icon 313 (as shown in FIG. 5). In the preferred embodiment, an Ajax Layer appears when a user scrolls over or clicks on Register icon 313. Alternatively, by clicking on the Register icon 313, the consumer may proceed to a separate registration page on the advertisement platform. Similarly, the consumer may scroll over or click on Forgot Password icon 315 or My Credits icon 317. The consumer may also click on Checkout icon 319, which preferably links to a separate checkout webpage, either as part of the advertisement platform or a certain publisher's website (e.g., a magazine publisher for Magazine X).

Optionally, the number of credits that are necessary to earn a good or service may be displayed as in box 309. In the depicted example, a consumer may receive 1 issue of Wired Magazine for every 2 credits earned. Preferably, the system will display a plurality of video advertisements that a consumer may select and view, for example, as shown in box 311.

When a consumer scrolls over a selected advertisement icon 321, as shown in FIG. 3B, the consumer is able to select advertisement icon 321 for viewing by clicking the “Play video” link 323 (or similar option) on advertisement icon 321. By scrolling over advertisement icon 321, certain information is displayed, including, for example, identification of the advertisement, the rewards available for selecting and viewing the advertisement, etc.

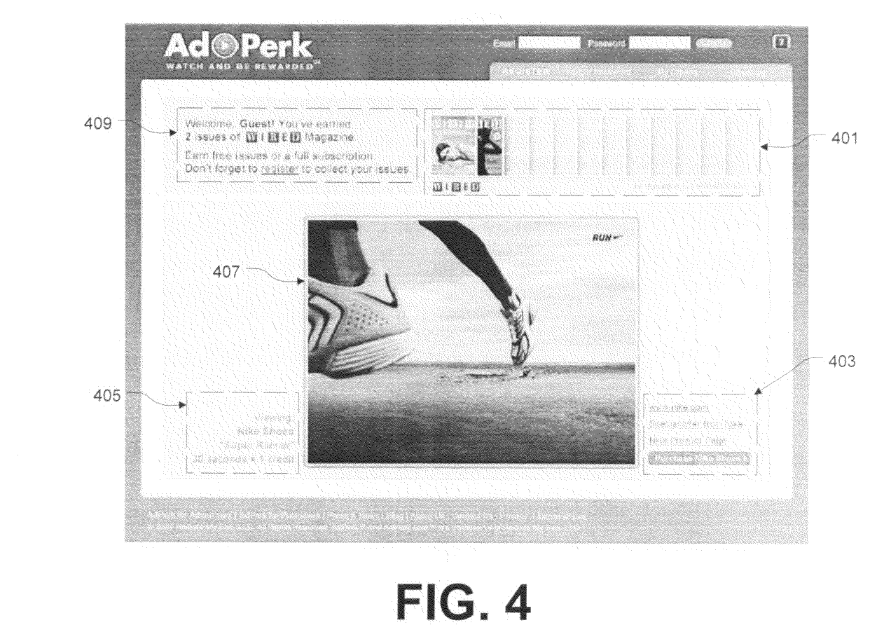

Once a consumer selects an advertisement to view (e.g., by clicking on “Play video” link 323 or a similar), the consumer is preferably directed to another webpage where the consumer views the selected advertisement. As shown in FIG. 4, the consumer, still a guest at this point, views selected advertisement 407 (the corresponding advertisement as shown in advertisement icon 321) on the advertisement platform for use with the consumer-choice, incentive based, alternative payment method and advertising system of the preferred embodiment according to the present invention.

The number of issues of the magazine that the consumer guest has earned is preferably displayed, for example, as shown in box 401. The consumer guest here has not yet registered or logged in. Rather, the consumer guest chose to select and view one or more video advertisements from the selection list (as shown on FIGS. 3A and 3B and corresponding to step 107 in FIG. 1) prior to registering or logging in.

Additional information regarding the advertiser is preferably displayed, for example, links to the advertiser's website, as depicted in box 403. Box 405 provides a description of advertisement 407 currently being viewed. Finally, information regarding the number of issues the guest has earned based on the number of video advertisements the guest has selected, viewed, and verified viewing of, is preferably displayed, such as shown in box 409.

FIG. 5 shows a sample screen shot of the registration Ajax Layer on the advertisement platform for use with the consumer-choice, incentive based, alternative payment advertising system of the preferred embodiment according to the present invention. When a consumer scrolls over or clicks on Register icon 313 (of FIGS. 3A and 3B), the Ajax Layer box 501 appears, which allows the consumer to input various information and register with the advertisement platform (step 103 of FIG. 1).

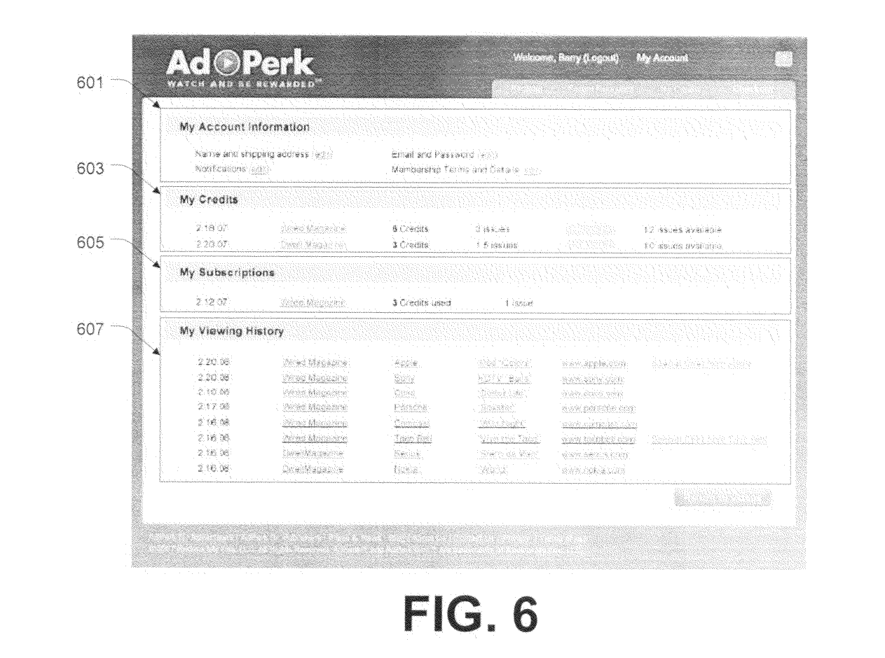

Turning next to FIG. 6, depicted is a sample screen shot of a user's account information page of the advertisement platform for use with the consumer-choice, incentive based, alternative payment advertising system of the preferred embodiment according to the present invention. After a consumer registers (step 103 of FIG. 1) and/or logs in (step 105 of FIG. 1), the consumer is able to view his account information.

My Account Information box 601 allows the consumer to view and edit his profile, including, for example, name, shipping address, billing address, notification settings, email, and password. My Credits box 603 shows the number of credits earned. It may include a variety of information, including, for example, the date on which the credits were earned, the number of credits earned, which goods or services the credits were earned towards, and the maximum amount of credits available to be earned toward a certain good or service. Although not shown, the advertisement platform allows consumers to earn general credits that may be applied to a variety of consumer-selected goods or services.

My Subscriptions box 605 contains information pertaining to the goods or services that the consumer has redeemed by using earned credits. My Viewing History box 607 contains information regarding the consumer's viewing history of selected advertisements. The viewing history preferably includes links to advertisers' websites associated with the viewed advertisements and other special offers from the advertisers.

One of skill in the art will readily appreciate that other information may be included on the account information page shown in FIG. 6. For example, the page may show a list of advertisements that the consumer previously selected that he wants to view at a future time.

After the consumer views the advertisement (step 109 of FIG. 1), the consumer verifies his viewing (step 111 of FIG. 1), as shown for example, in FIG. 7, which depicts a sample screen shot of a verification screen including of the advertisement platform for use with the consumer-choice, incentive based, alternative payment method and advertising system of the preferred embodiment according to the present invention. After viewing the advertisement, the consumer verifies viewing by entering the appropriate text within box 701. Other verifications methods may also be implemented, including, for example, questions related to the advertisement or other questions that may be of particular interest to the advertiser. The information from such questions preferably is provided to the advertiser via the advertisement platform's reporting mechanisms.

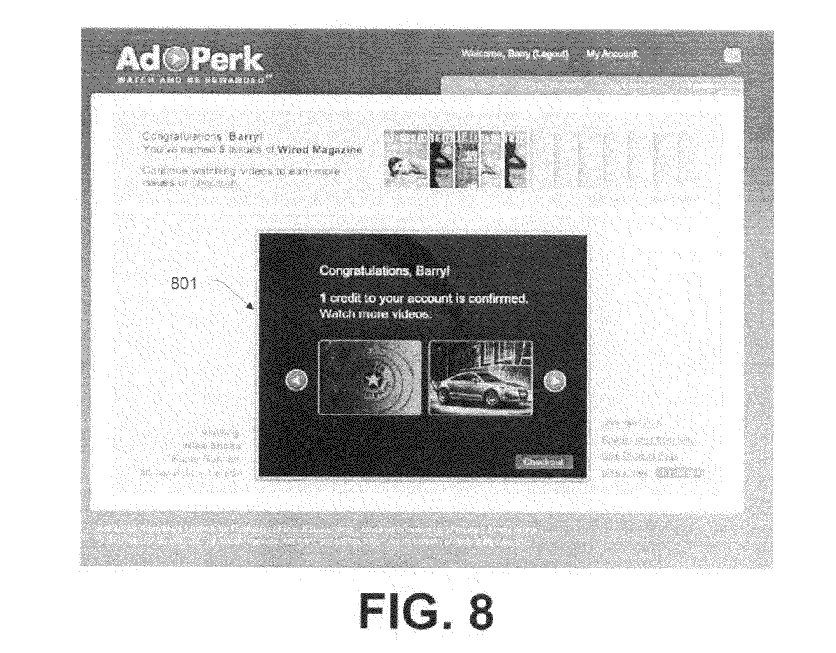

Finally, FIG. 8 depicts a sample screen shot of a confirmation screen of the advertisement platform for use with the consumer-choice, incentive based, alternative payment method and advertising system of the preferred embodiment according to the present invention. Box 801 shows the confirmation for completing the viewing of a user-selected advertisement.

While the present invention has been described with reference to the preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A method of incentive based advertising, said method comprising the steps of:
presenting a plurality of advertisements to a user for selection;
allowing said user to select one of said advertisements, wherein said user views said selected advertisement; and
providing benefits to said user for viewing said selected advertisement.

2. The method according to claim 1, wherein said user logs in or enrolls either before or after selecting and viewing one or more of said advertisements.

3. The method according to claim 1, said method further comprising the step of:
enrolling said user.

4. The method according to claim 2, wherein user login or registration information is provided via a third party.

5. The method according to claim 1, said method further comprising the step of:
storing historical information about advertisements presented to the user.

6. The method according to claim 1, wherein said benefits are selected from the group consisting of credits to pay for items, conditional credits to pay for items, money, and combinations including at least one of the foregoing benefits.

7. The method according to claim 6, wherein said user redeems said benefits.

8. The method according to claim 1, further comprising the step of:
reporting information about said advertisements.

9. The method according to claim 1, said method embodied in a venue selected from the group consisting of a dedicated website, a dedicated webpage, a portion of another website, an inset page in a dedicated webpage, an inset page in another webpage, an interactive television system, an interactive radio system, a telephonic system, and combinations including at least one of the foregoing venues.

10. The method according to claim 9, wherein said advertisements are presented through a medium selected from the group consisting of a dedicated website, a dedicated webpage, another website, a portion of another website, an inset page in a dedicated website, an inset page in a dedicated webpage, an inset page in another website, an inset page in another webpage, television, radio, telephonic medium, and a combination including at least one of the foregoing medium.

11. The method according to claim 1, wherein third parties pay for advertisements presented to said user.

12. The method according to claim 11, wherein said third party only pays for said viewing of said advertisement to said user if said viewing is confirmed.

13. The method according to claim 1, wherein said user is offered to participate to select and view advertisements through a medium selected from the group consisting of a dedicated website, a dedicated webpage, a portion of website, an inset page in a webpage, a pop-up webpage, a print medium, a telephonic medium, television, email, a public display, and combinations including at least one of the foregoing mediums.

14. The method according to claim 1, further comprising the step of:
said user confirming said viewing of said selected advertisement.

15. The method according to claim 1, wherein said plurality of advertisements available for selection by said user is determined by advertiser defined parameters.

16. An incentive based advertising system comprising:
a selection subsystem including a plurality of previews of advertisements selectable for individual presentation; and
a presenting subsystem for presenting a selected advertisement to a user based on said user choosing at least one of said previews;
wherein said user earns benefits for being presented with said selected advertisement.

17. The advertising system of claim 16, further comprising a login subsystem.

18. The advertising system of claim 16, further comprising an enrollment subsystem for enabling said user to enroll in said advertising system to receive said benefits.

19. The advertising system of claim 17, wherein the login system accepts login information from a user or a third party.

20. The advertising system of claim 16, further comprising a storage subsystem containing information about advertisements presented to the user.

21. The advertising system of claim 16, wherein said benefits are selected from the group consisting of credits to pay for items, conditional credits to pay for items, money, and combinations including at least one of the foregoing benefits.

22. The advertising system of claim 16, further comprising a verification subsystem for determining and confirming whether the user has viewed the advertisement, comprehended the advertisement, or both viewed and comprehended the advertisement.

23. The advertising system of claim 16, further comprising a reporting subsystem for reporting information about advertisements.

24. The advertising system of claim 16 embodied in a venue selected from the group consisting of a dedicated website, a dedicated webpage, a portion of another website, an inset page in a dedicated webpage, an inset page in another webpage, an interactive television system, an interactive radio system, a telephonic system, and combinations including at least one of the foregoing venues.

25. The advertising system of claim 24, wherein advertisements are presented through a medium selected from the group consisting of a dedicated website, a dedicated webpage, another website, a portion of another website, an inset page in a dedicated website, an inset page in a dedicated webpage, an inset page in another website, an inset page in another webpage, television, radio, telephonic medium, and a combination including at least one of the foregoing medium.

26. The advertising system of claim 16 embodied in an advertising platform website.

27. A method of alternative payment in an incentive based advertisement system, said method comprising the steps of:
presenting one or more advertisements from a first entity for selection by a user;
enabling said user to select one of said advertisements;
presenting said selected advertisement to said user; and
providing benefits from a second entity to said user for selecting said advertisement;
wherein said user redeems said benefits as payments for one or more items provided by said second entity; and
wherein said second entity receives payment for said redeemed benefits.

28. The method according to claim 27, wherein said one or more advertisements available for selection by said user is determined by advertiser-defined parameters.

29. The method according to claim 27, wherein said benefits are only provided to said user after said user confirms full presentation of said advertisement.

30. The method according to claim 27, wherein said first entity provides said payment to said second entity for said user being presented said selected advertisement.

31. The method according to claim 27, wherein said method further comprises the step of:
receiving a commission from said payment to said second entity.
